(19) United States
(12) Patent Application Publication
(10) Pub. No.: US 2003/0002445 A1
(43) Pub. Date: Jan. 2, 2003

(54) Virtual advisor

(76) Inventors: Laurent Fullana, Princeton Junction, NJ (US); Philip A. Matena, Rumson, NJ (US); Gabriel Herbreteau, Aulnay sous Bois (FR)

Correspondence Address: FISH & NEAVE, 1251 AVENUE OF THE AMERICAS, 50TH FLOOR, NEW YORK, NY, 10020-1105, US

(21) Appl. No.: 10/164,220

(22) Filed: Jun. 4, 2002

Related U.S. Application Data
(60) Provisional application No. 60/295,696, filed on Jun. 4, 2001.

(51) Int. Cl. H04J 1/16

(52) U.S. Cl. 370/241

(57) ABSTRACT

Systems and methods for providing a virtual advisor are provided. These systems and methods may in response to a user's queries, provide electronic advice, answers, suggestions, or any other information or combination thereof using case-based reasoning, live experts, or both. These systems and methods may be implemented on any suitable stand-alone or distributed system (i.e., Internet-based or non-Internet-based computer network).

### CROSS REFERENCE TO RELATED APPLICATION

This application claims the benefit of United States Provisional Patent Application No. 60/295,696, filed Jun. 4, 2001.

### BACKGROUND OF THE INVENTION

This invention relates to electronic systems and methods for providing answers to questions provided by users. More particularly, this invention relates to electronic systems and methods for providing virtual advice utilizing case-based reasoning and advice from live experts.

When a product designer needs to solve a problem, he or she may have many sources from which he or she may obtain information or advice. For example, a designer may obtain advice or information from in-house support networks, suppliers, consultants, universities, literature, or other sources. However, the advice, answers, or information provided by these sources are prone to human error and subject to a person's availability.

It is, therefore, an object of the invention to provide computer-based systems and methods that provide information and advice for user-provided queries.

### BRIEF DESCRIPTION OF THE DRAWINGS

FIG. 1 is a block diagram of an illustrative system that may be used to implement various embodiments of the present invention;

FIG. 2 is a block diagram of an illustrative system that may be used in accordance with embodiments of the present invention;

FIG. 3 is a block diagram of an illustrative arrangement for the access device of FIG. 1 and the personal computer of FIG. 2 in accordance with embodiments of the present invention;

FIG. 4 is an illustrative block diagram for an illustrative architectural schematic of the virtual advisor in accordance with embodiments of the present invention;

FIG. 5 is an illustrative flowchart in accordance with various embodiments of the present invention;

FIGS. 6A and 6B are illustrations of an illustrative formulation information screen display in accordance embodiments of the present invention;

FIG. 7 is an illustration of an illustrative ingredients information screen display in accordance embodiments of the present invention;

FIG. 8 is an illustration of an illustrative user logon screen display in accordance with embodiments of the present invention;

FIG. 9 is an illustration of an illustrative screen display in accordance with embodiments of the present invention;

FIG. 10 is an illustration of an illustrative screen display in accordance with embodiments of the present invention;

FIG. 11 is an illustration of an illustrative screen display in accordance with embodiments of the present invention;

FIG. 12 is an illustration of an illustrative screen display in accordance with embodiments of the present invention;

FIG. 13 is an illustration of an illustrative screen display in accordance with embodiments of the present invention;

FIG. 14 is an illustration of an illustrative screen display in accordance with embodiments of the present invention;

FIG. 15 is an illustration of an illustrative screen display in accordance with embodiments of the present invention;

FIG. 16 is an illustration of an illustrative screen display in accordance with embodiments of the present invention;

FIG. 17 is an illustration of an illustrative screen display in accordance with embodiments of the present invention;

FIG. 18 is an illustration of an illustrative screen display in accordance with embodiments of the present invention; and

FIG. 19 is an illustrative example of a business model in accordance with some embodiments of the present invention.

### SUMMARY OF THE INVENTION

Electronic systems and methods for providing a virtual advisor are provided. Various illustrative features and displays of illustrative embodiments of the present invention are described in U.S. Provisional Patent Application No. 60/295,696, filed Jun. 4, 2001, which is hereby incorporated by reference herein in its entirety.

A virtual advisor may be, for example, any system that, in response to a user's queries, provides electronic advice, answers, suggestions, or any other information or combination thereof using case-based reasoning, live experts, or both. The virtual advisor may be implemented on any suitable stand-alone or distributed system (i.e., Internet-based or non-Internet-based computer network).

### DETAILED DESCRIPTION OF EMBODIMENTS OF THE INVENTION

The present invention includes a virtual advisor and features thereof. The virtual advisor provides electronic advice, answers, suggestions, or any other information to users in response to their queries, using case-based reasoning, live experts, or both. In some embodiments, the virtual advisor may utilize case-based reasoning (e.g., textual, conversational, structural, etc.) to provide solutions to a user's query. Case-based reasoning is a technique whereby problems are solved using solutions to previous problems or questions (“cases”). These cases may be stored in a database or in any other suitable searchable electronic format, and on any suitable searchable storage device (e.g., hard disk drive, memory card, etc.). Examples of case-based reasoning systems are the engines provided by KAIDARA SOFTWARE, E-GAIN, and PRIMUS.

For example, a user may enter a particular query that represents a problem or question into the virtual advisor. The virtual advisor may then search for previous cases that have features related to or similar to the current problem or question. Features that are related to or similar to the current problem or question may include, for example, parameters or other characteristics that the current query has in common with previous cases. Commonality between the user's query and previous cases may be determined by assigning predefined or weighted values to various parameters or characteristics in a user's query and comparing such values with the values assigned to stored cases. For example, in a virtual advisor for the personal care products industry, parameters and characteristics, which may be predefined or weighted, may include viscosity, PH, molecular weight, price, or any other suitable physical or nonphysical property.

After analyzing the parameters and characteristics of the user's query and searching for cases that have similar features to the user's query, the virtual advisor may provide the user with one or more solutions. To further narrow the solutions provided to the user, the virtual advisor may prompt the user to enter more specific questions or information in an order that may be based upon case-based reasoning, predefined or weighted values, or both, and assigned to the advisor-prompted questions or requests for information.

To enhance the advisor's ability to provide accurate solutions to user queries the advisor may store new user queries, answers to the user's new queries, and any other suitable information on the advisor's searchable storage device for use in providing solutions to subsequent user queries. To improve the efficiency in providing solutions to user queries, information stored by the virtual advisor may be organized and categorized using predefined values, hierarchical taxonomies, ordered lists, or any other suitable method for organizing and categorizing information.

When a solution cannot be determined using case-based reasoning, the virtual advisor may provide the user with electronic access to a live expert to receive advice on the problem. For example, the virtual advisor may establish a communications session between the user and a live expert using real-time messaging, email, Internet-based (or other network based) telephony, by automatically establishing a telephone link, or using any other suitable approach.

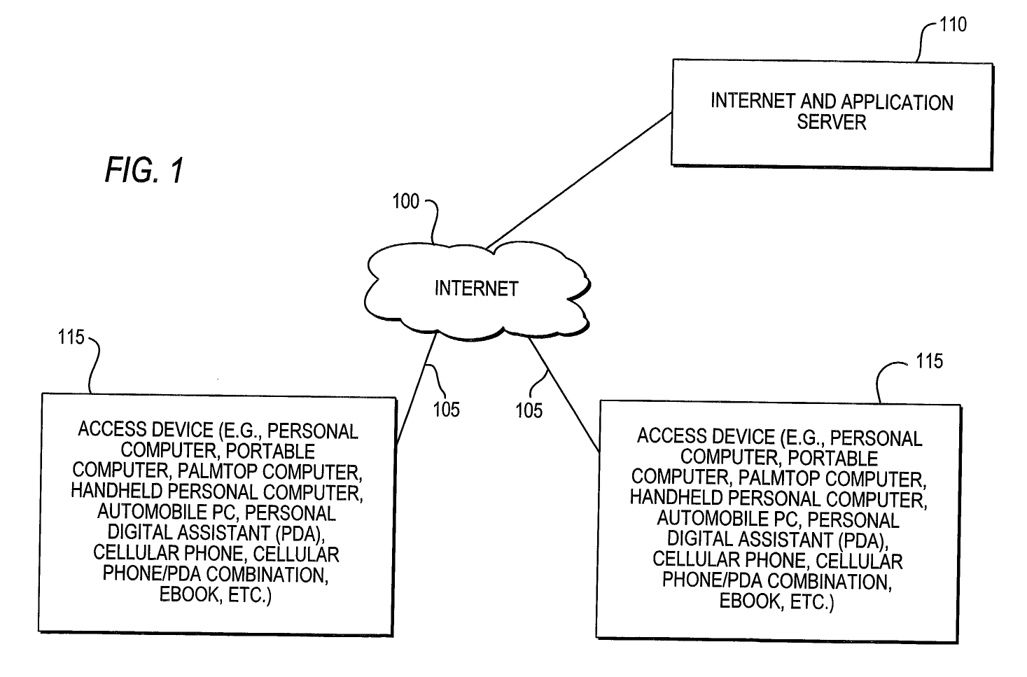

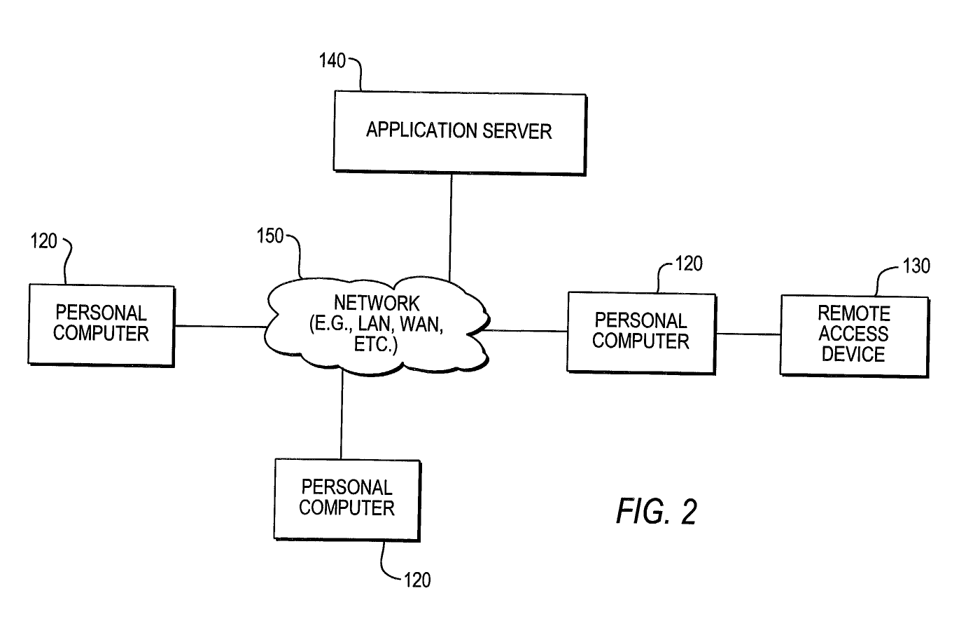

The virtual advisor may be implemented using any suitable computer-based approach. For example, non-on-line client-server or peer-to-peer based approached or, preferably, an on-line (i.e., Internet-based) approach, may be used. If desired a combination of these approaches may be used. Illustrative on-line and non-online based arrangements for a virtual advisor system are shown in FIGS. 1 and 2, respectively. In the illustrative on-line arrangement of FIG. 1 access devices 115 may include any device or combination of devices suitable for providing Internet access to a user of the system. Access devices may include, for example, any suitable personal computer (PC), portable computer (e.g., a notebook computer), palm computer, handheld personal computer (H/PC), automobile PC, personal digital assistant (PDA), Internet-enabled cellular phone, combined cellular phone and PDA, e-book, or other device suitable for providing Internet access.

Internet and application server 110 may be any server suitable for providing on-line access to a virtual advisor web site, or other Internet-based site. Internet application server 110 may, for example, provide one or more pages to access devices 115 using one or more suitable protocols (e.g., Hypertext Transfer Protocol (HTTP) and Transmission Control Protocol/Internet Protocol (TCP/IP)). The pages may be defined using, for example, any suitable markup language (e.g., Hypertext Markup Language (HTML), Dynamic Hypertext Markup Language (DHTML), pages defined using Extensible Markup Language (XML), Javaserver Pages (JSP), Active Server Pages (ASP), or any other suitable approaches). The pages may include scripts, computer code, or subsets of computer code, that define mini-programs (e.g., Perl scripts, Java applets, Enterprise JavaBeans (EJB), or any other suitable approaches). The system may be designed using suitable modular approaches such as, for example, Java 2 Platform—Enterprise Edition (J2EE), Component Object Model (COM), Distributed component Object Model (DCOM), or any other suitable approach. Internet application server 110 may also run a database engine suitable for maintaining a database of user information such as, for example, Microsoft SQL Server, Oracle 8i, or any other suitable database engine. In practice, features of Internet and application server 110 may be integrated into a single server, or may be distributed across multiple servers that are interconnected via Internet 100.

Links 105 may include any transmission medium suitable for providing Internet access to access devices 115. Links 105 may include, for example, a dial-up telephone line, a computer network or Internet link, an infrared link, a radio frequency link, a satellite link, a digital subscriber line link (e.g., a DSL link), or any other suitable combination of such links. Different links 105 may be different types depending on, for example, the particular type of access devices 115.

Any protocol or protocol stack suitable for supporting communications between access devices 115 and Internet and application server 110 over links 105 based on the particular device 115 and link 105 may be used. For example, Ethernet, Token Group, Fiber Distributed Data Interface (FDDI), Circuit-Switched Cellular (CSC) Cellular Digital Packet Data (CDPD), RAM mobile data, Global System for Mobile communications (GSM), time division multiple access (TDMA), code division multiple access (CDMA), wireless application protocol (WAP), serial line Internet protocol (SLIP), point to point protocol (PPP), Transmission Control Protocol/Internet Protocol (TCP/IP), Sequenced Packet Exchange and Interwork Packet Exchange (SPX/FPX) protocols, or any other suitable protocol or combination of protocols may be used.

FIG. 2 shows an illustrative arrangement for a client-server-based non-online arrangement in accordance with some embodiments of the present invention. In the client/server arrangement of FIG. 2, personal computers 120 (sometimes also referred to herein as access devices) are interconnected via network 150 to application server 140. Application server 140 may be any server suitable for running the virtual advisor. Application server 140 may run a suitable database engine such as, for example, Microsoft SQL Server, Oracle 8i, or any other suitable database engine. In practice, features of Internet and application server 110 may be integrated into a single server, or may be distributed across multiple servers that are interconnected via network 150.

Network 150 may be any suitable local area network (LAN), wide area network (WAN), or any other suitable network. Personal computers and their interconnection via networks, are well known. Personal computers 120 may run suitable e-mail, HTTP, or other clients and client applications for providing users with access to the features of the system. In still another suitable approach, personal computers 120 may run suitable Internet browsers to provide users with access to the Internet via an Internet server (not shown). If desired, or more personal computers 120 may be accessed by remote access device 130 to provide remote access to user to the system. Remote access device 130 may be any suitable device, such as a personal computer, personal digital assistant, cellular phone, or other device with remote access capabilities.

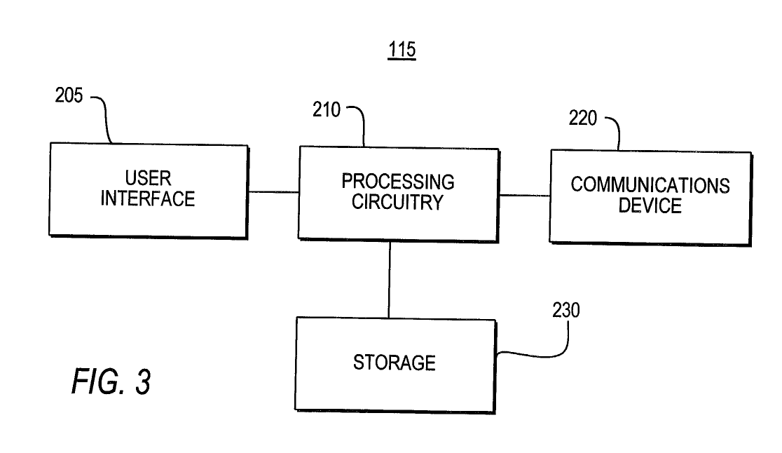

FIG. 3 shows an illustrative, generalized arrangement for the access devices 115 of FIG. 1. Access devices 115 may have, for example, user interface 205, processing circuitry 210, communications device 220, and storage device 230. User interface 205 may be any suitable input device, output device, or combination thereof. User interface 205 may include, for example, a pointing device, keyboard, touch-pad, touch screen, pen stylus, voice recognition system, mouse, trackball, cathode ray tube (CTR) monitor, liquid crystal display (LCD), voice synthesis processor and speaker, or any other suitable input or output device. Processing circuitry 210 may include any suitable processor or group of processors, such as an Intel Pentium microprocessor, and other suitable circuitry (e.g., input/output (I/O) circuitry, direct memory access (DMA) circuitry, etc.). Communications device 220 may be any device suitable for supporting communication over links 105. Communications device 220 may include, for example, a modem (e.g., any suitable analog or digital standard, cable or cellular modem), network interface card (e.g., an Ethernet card, token group card, etc.), wireless transceiver (e.g., an infrared, radio, or other suitable analog or digital transceiver), or other suitable communications device. Storage 230 may be any suitable memory, storage device, or combination thereof, such as RAM, ROM, flash memory, a hard disk drive, etc.

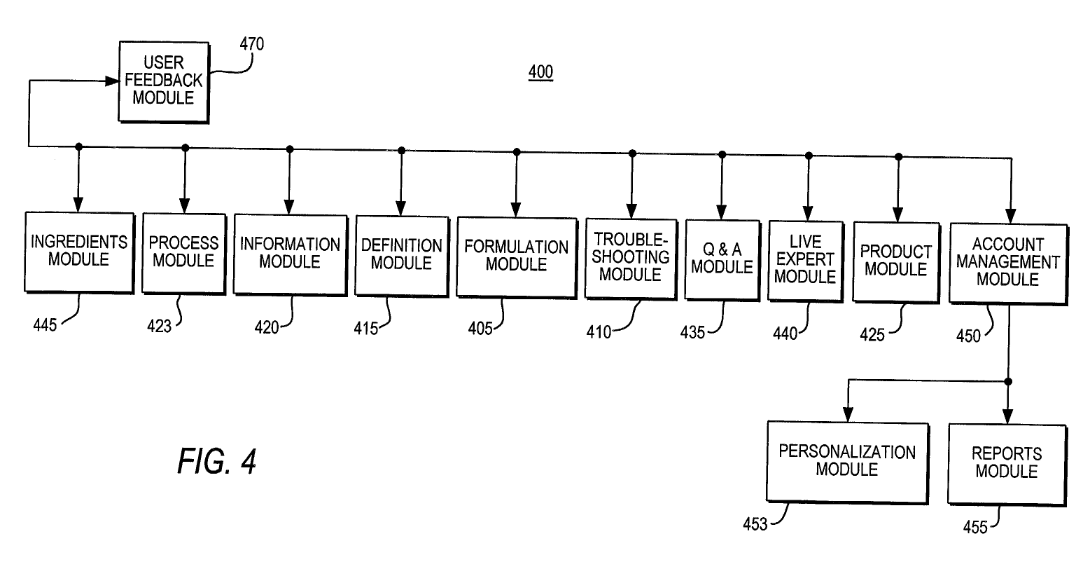

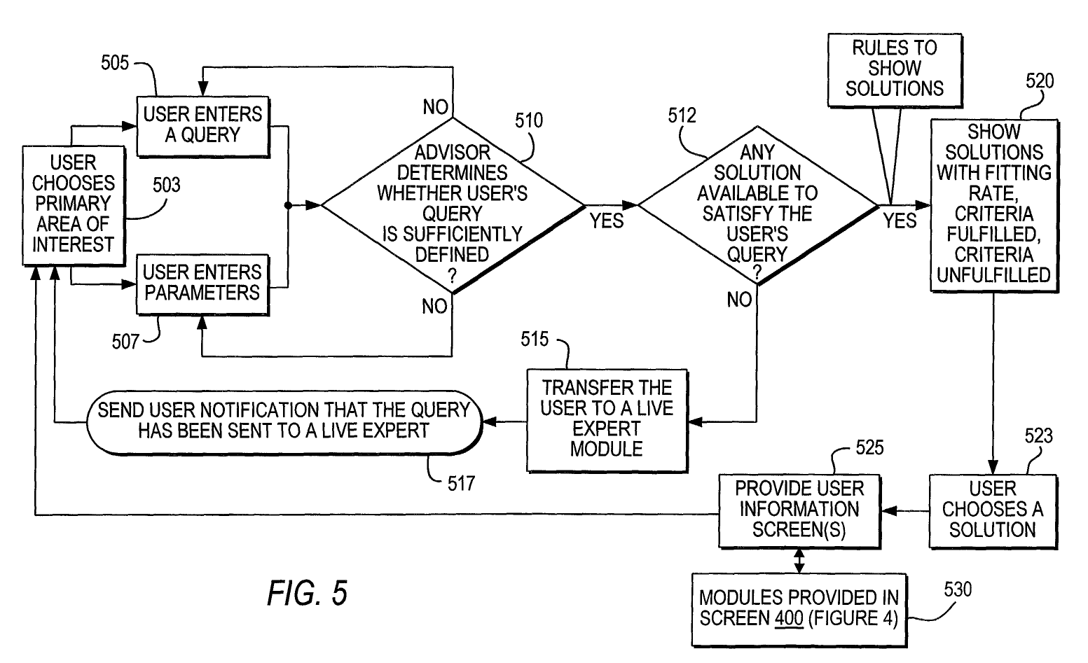

FIG. 4 is an illustrative block diagram 400 of various aspects the advisor system. After logging onto the advisor system, the advisor may provide the user with various user selectable modules, the opportunity to enter a query, and may search one or more of the modules for solutions to the users query. For example, the virtual advisor may include user selectable modules such as formulation module 405, troubleshooting module 410, definition module 415, information module 420, product module 425, process module 423, question and answer module 435, live expert module 440, ingredients module 445, and account management module 450. The illustrative modules provided herein may also include various sub-modules. For example, account management module 450 may also include sub-modules such as personalization module 453 and reports module 455. This list of modules is only illustrative as any other suitable module, sub-modules, or combination of modules may exist for any other suitable service or feature (e.g., legal, regulatory, safety, etc.).

Formulation module 405 may assist a user in finding and selecting a specific formula for a particular product. For example, it may provide the user formulas using case-based reasoning, live experts, or both.

Ingredients module 445 may assist a user in searching for and identifying specific ingredients used in creating a particular formula (e.g., any component used in creating a formula), suitable substitutes for specific ingredients, or any other information related to a specific ingredient. For example, it may provide the user specific ingredients, substitutes for ingredients, or any other information related to specific ingredients using case-based reasoning, live experts, or both.

Troubleshooting module 410 may assist a user in searching for and identifying troubleshooting information to solve user-defined problems. It may provide the troubleshooting information using case-based reasoning, live experts, or both. For example, troubleshooting information for a personal care formula may include the best method for making an ingredient dissolve into solution (e.g., particular temperatures), and any other physical, or nonphysical characteristic that may assist user in solving a defined problem.

Question and answer module 435 may assist a user in searching for and identifying predefined questions and answers that may help solve a user defined problem. Predefined questions and answers may, for example, include questions and answers related to specific technologies, formulas, ingredients, methods of manufacturing, or any other related information. Module 435 may provide the user questions and answers using case-based reasoning, live experts, or both.

Live expert module 440 may assist a user in submitting a user query to a live expert (i.e., a human being) in a particular field.

User feedback module 470 may provide the user with an opportunity to submit feedback on the advisor's performance and submit any other information with respect to improving any aspect of the advisor. To allow a user to submit feedback, the advisor may provide the user a feedback form, which may be based on the particular feature of the advisor being evaluated. For example, the feedback form may vary according to the particular module being rated (e.g., formulation module, ingredients module, etc.).

After the user prepares the advisor feedback form, the user may submit his feedback using the advisor or any other suitable method of communication. After submitting the feedback form, the user may receive a notification that such feedback was successfully received by the appropriate entity or individual. The notification may be provided through any suitable method of communication (e.g., email, pop-up message, regular mail, facsimile, etc.).

Process module 423 may assist a user in searching for and identifying processes. Processes may include, for example, any suitable method or combination of methods used to create a formula or a product. Process may also include manufacturing techniques, techniques for obtaining a pure substance, cost saving techniques for creating a product or a substance, etc. Module 423 may provide the user processes using case-based reasoning, live experts, or both.

Definition module 415 may provide the user with the definitions of commonly used terms. For example, definitions may be provided to users using a local or remote on-line or non-online database, or any other suitable source for providing and defining terms to a user.

Information module 420 may provide the user with a summary of the information found in one or more of the advisor's modules relating to a user's query. For example, Module 420 may provide the user of summary of the information found in modules 405, 445, 410, 435, 425, 423, set forth above.

Account management module 450 may analyze user behavior (e.g., number of log-ins, time spent on the advisor system, time spent in specific modules, type and number of documents accessed, types of searches, number of questions submitted to a live expert, etc.) for the purposes of obtaining data, which may provide the user, the advisor owner, or a third party information with respect to marketing, billing, or any other suitable purpose. Account management module 450 may also include sub-modules such as, for example, reports module 455 and personalization module 453. This list of sub-modules is only illustrative.

Reports module 455 may create reports and give data in various computer readable formats (e.g., spread sheets, word processing, database, etc.) with respect to information tracked in account management module 450. For example, reports module 455 may generate reports that include, for example, the number of log-ins for a particular user or group of users, the time spent on the advisor system for a particular user or group of users, the type and the number of documents accessed by a particular user or group of users, the types of searches performed by a particular user or group of users, the number of questions submitted to a live expert by a particular user or group of users, and any other suitable information with respect to a particular user or group of users.

Personalization module 453 may be utilized by users to personalize the advisor or make the advisor more user-friendly. For example, personalization module 453 may include features such as a “my formulations” section for saving and displaying a particular user's selected formulas, a “my products” section for saving and displaying a user's selected ingredients, a “my troubleshooting” section for saving and displaying a user's selected troubleshooting techniques and information, a “my questions and answers” section for saving and displaying a user's selected questions and answers, a “preferred suppliers” section for saving and displaying a user's preferred list of suppliers, a “historical activities” section for saving and displaying all of the user's activities performed on the virtual advisor, and any other suitable personalization feature.

Some embodiments of the present invention may include a samples module (not shown). A samples modules may provide the user the opportunity to receive samples of products, ingredients, materials or other items listed on the virtual advisor.

Some embodiments of the present invention may include an e-learning module (not shown). An e-learning module, for example, may employ web-based instruction or other suitable distance learning techniques (e.g., streaming videos, etc.). The e-learning module may include user training based on a user's current query or previous queries. The e-learning module may also include user training based on the selection of specific training material defined by the user (e.g., by topic, by product, or by any other suitable means). The e-learning module may further include user training based upon an initial assessment of a user's abilities as determined by the advisor (e.g., an on-line test, etc.), or through case based reasoning.

FIG. 5 is an illustrative flowchart of a process for allowing a user to enter a query into the advisor and search one or more modules for solutions to the user's query. Step 503 may allow the user to select a primary area of interest. For example, a primary area of interest for the personal care products industry may include areas such as shampoos, conditioners, etc. At Step 505 the user may be provided with an opportunity to enter a query and the opportunity to select one or more modules in which to receive information from; optionally, at step 507 the user may be provided an opportunity enter one or more parameters to further define the user's query. To enter a query and a parameter, the user may utilize natural language semantics, markup language semantics, or any other suitable type of language semantics. The user may also enter a query and a parameter using one or more successive screens (e.g., parametric search), a Boolean query, any other suitable approach, or any suitable combination thereof. Any suitable user interface elements may be used such as, a reply, check-boxes, text fields, drop-down lists, or any other suitable user interface element.

After the user enters a query, the advisor at step 510 may determine whether the user's query is sufficiently defined. The advisor may determine whether a user's query is sufficiently defined using, for example, a predefined rule or set of rules, case-based reasoning, or both.

When the advisor determines that the user's query is not sufficiently defined, the advisor may request that the user enter additional information to more particularly define the user's initial query (step 510). In some embodiments, the advisor may generate and provide the user questions in order to more particularly define the user's query. These questions may be provided to the user based upon previous entries made by the user in the current query, predefined and weighted parameters (as described in detail above), or both. For example, in a virtual advisor for the personal care products industry, parameters that may be predefined and weighted, may be PH, molecular weight, viscosity, cost objectives, or any other suitable physical or nonphysical characteristic of a product that could assist in defining and identifying information with respect to the user's query.

Once the advisor determines that the user's query has been sufficiently defined, such that the user has entered sufficient information and, if provided, all of the advisor's questions have been exhausted, the advisor may perform a search using, for example, a predefined rule or set of rules and case-based reasoning to generate a solution to the user's query (step 512). For example, a rule may include generating a solution to the user's query based on matching a certain percentage of the user entered information with information assigned to and stored in cases on the advisor system.

When the advisor is unable to generate a solution with respect to the user's query, the advisor may provide the user's query to live expert module 440 (step 515). For example Live expert module 440 may submit a question or a problem to a live expert via a live chat (e.g., an instant message forum), e-mail, video link, or any other suitable communications medium. The user may also have the ability to submit file attachments or any other suitable electronic form of data (e.g., photographs, video, spread sheets, etc.).

In some embodiments, live expert module 440 may capture, store, and transfer all previous exchanges between the advisor and the user to the live expert. The user may also be allowed to enter any additional information to further define his or her query to the live expert.

Live experts may include persons such as in house experts, outsourced experts, or both. Such experts may be located anywhere in the world. The advisor may choose to send a user's query to a particular expert or combination of experts based upon various criteria such as, for example, expertise, cost, or any other suitable criteria.

After the advisor has successfully transferred the user's query and any other appropriate information to a live expert, the advisor may provide the user with a notification that the transfer was successful (step 517). The notification may be accomplished through a variety of methods such as, for example, an e-mail, an instant message, a telephone call, a page, a teletext message, or through any other suitable communications medium.

If the advisor is able to identify one or more solutions to the user's query, the advisor may provide the user a list of these solutions (step 520). The list provided may fit all or part of the user's query. The list provided may also be based upon a predefined set of rules. For example, these rules may require solutions to a user's query have more than 50% of a user's defined parameters to be displayed. When such a rule is used, the solutions may be displayed, for example, with a percentage corresponding to the number of user defined parameters that have been met. The list of solutions may also show or otherwise indicate which criteria has or has not been fulfilled.

When the advisor provides one or more solutions to the user's query, the user may select a desired solution (step 523). After selecting the desired solution, the user may be provided with one or more information screens (step 525). The information screens provided may based upon the particular module or modules selected by the user in step 505.

In some embodiments, the information screen provided may optionally allow the user to obtain information or utilize features from any module on the advisor system (step 530). For example, when a user is provided a formulation information screen the user may obtain information related to the user's query that may be found in question and answer module 435, troubleshooting module 410, user feedback module 470, product information module 425, ingredients module 445, process module 423, definition module 415, information module 420, account management module 450, and any other suitable module provided on the advisor system.

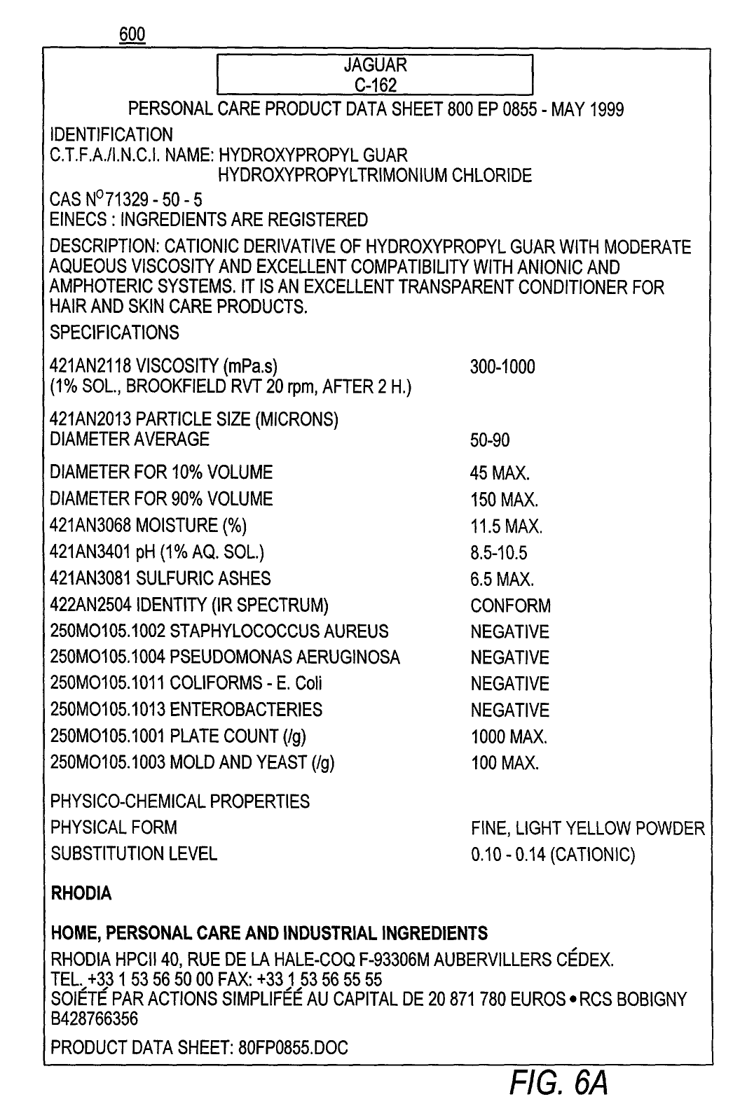

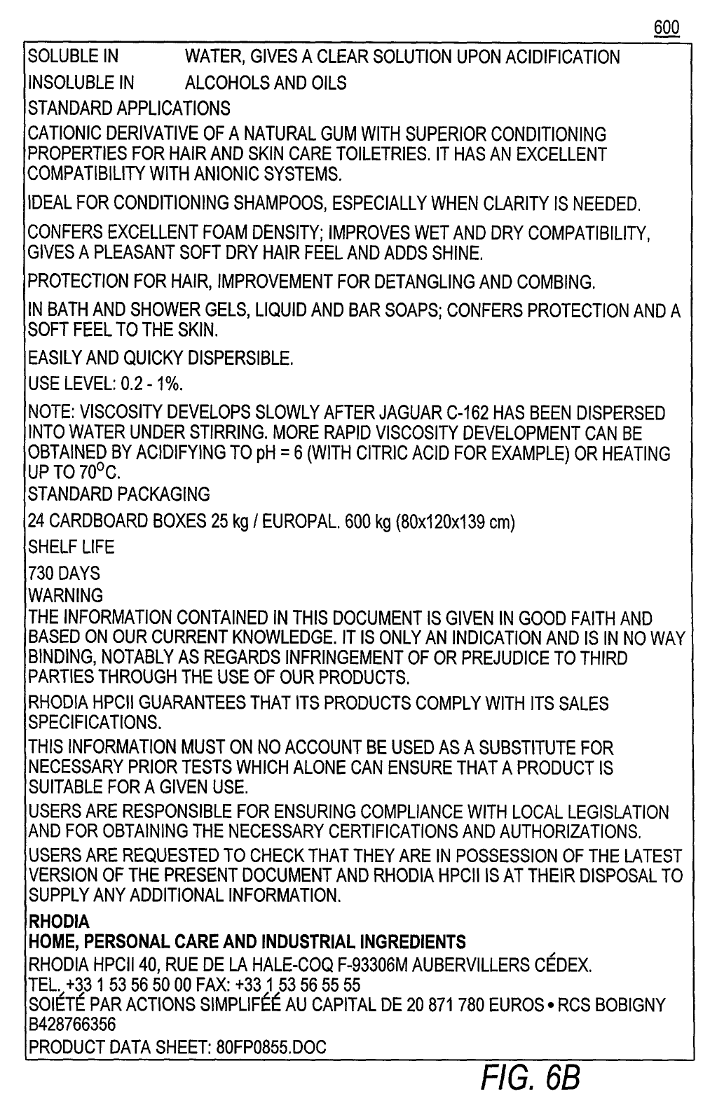

For example, when the user requests a formula and selects formulation module 405 (FIG. 4) in step 505, as described above, the virtual advisor may provide the user formula information screen 600, as illustratively shown in FIGS. 6A and 6B. Formula information screen 600 may, for example, include a formula title, a list of ingredients that may be used to create the desired formula, information on the desired formula ingredients, a recommended supplier for each ingredient in the desired formula, the manufacturing process to create the desired formula, the physical and chemical properties of the desired formula, the performance characteristics of the desired formula (e.g., shelf life, antibacterial properties, etc.), whether there is any known patent covering the desired formula, any regulation information (e.g., MSDS sheets, EPA, FDA approvals or investigations, trade information, etc.), storage information for the desired formula and the desired formula's ingredients, or any other suitable information or combination thereof.

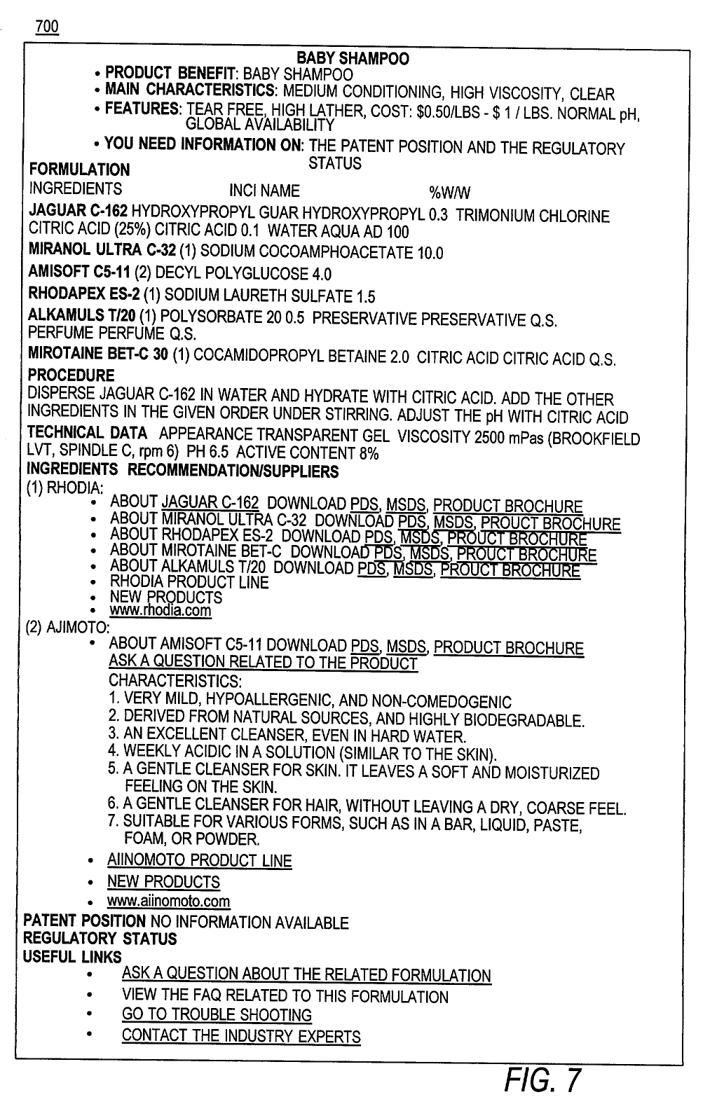

For example, assume the user requests ingredients for a personal care product. The virtual advisor may provide ingredient information in ingredient information screen 700, as illustratively shown in FIG. 7. Ingredient information screen 700 may, for example, include a particular ingredients name, a list of substitute ingredients that may be used in place of the selected ingredient, a recommended supplier for the ingredient and substitute ingredients, the manufacturing process to create the desired ingredient, the physical and chemical properties of the desired ingredient, the performance characteristics of the desired ingredient (e.g., shelf life, antibacterial properties, etc.), whether there is any known patent covering the desired ingredient, any regulation information (e.g., MSDS sheets, EPA, FDA approvals or investigations, trade information, etc.), storage information for the ingredient, or any other suitable information or combination thereof.

For example, assume the user requests questions and answers for a personal care product. The virtual advisor may provide questions and answers in a questions and answers information screen. A questions and answers information screen may, for example, include previous questions asked by other users on or related to the user's, frequently asked questions with respect to the user's query, and/or any other information on or related to the user's query or a links thereto.

For example, assume the user requests troubleshooting information for a personal care product. The virtual advisor may provide troubleshooting information in a troubleshooting information screen, as mentioned above. A troubleshooting information screen may, for example, include a summary of the user defined problem that lead to the selection of the particular remedy, symptoms of a particular problem, a solution to a particular problem, or a link thereto. A troubleshooting information screen may also include a section or link to a list of related troubleshooting issues or various other modules described herein.

For example, assume the user requests product. The virtual advisor may provide product information in a product information screen. A product information screen may provide the user with a list of products, which may be related to the user's query. For example, when the user enters a query for a particular ingredient, the product information screen may provide a list of products that contain the particular ingredient. For example, in the personal care products industry, when the user enters a query searching for information on an ingredient such as, for example, “Trimonium Chlorine”, the product information screen may, for example, display to the user the product “Baby Shampoo” and any information on or related to “Baby Shampoo” because “Trimonium Chlorine” is an ingredient found in “baby shampoo”.

For example, assume the user requests process information with respect to a personal care product. The virtual advisor may provide process information in a process information screen. A process information screen may, for example, include manufacturing techniques, techniques for obtaining a pure substance, cost saving techniques for creating a product or a substance, etc.

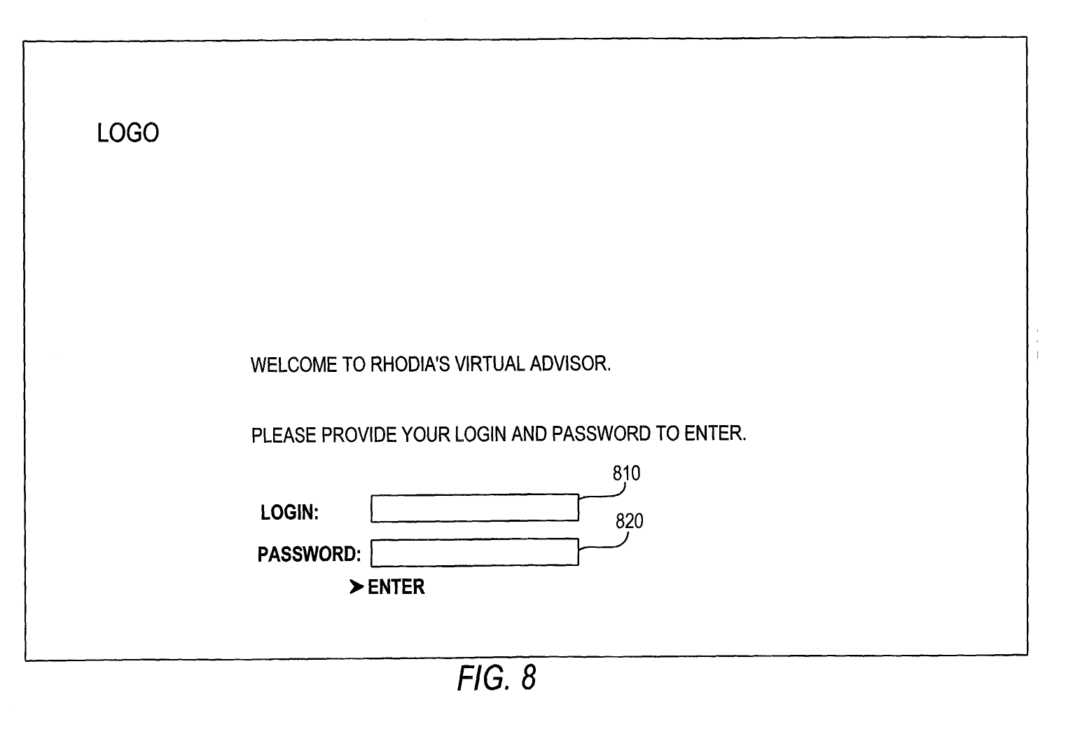

FIG. 8 shows an illustrative user log-on screen 800, that may be used in accordance with various embodiments of the present invention. User log-on screen 800 may, for example, include login region 810, password region 820, and links 830.

For example, login region 810 and password region 820 may allow the user to enter in a user name and a password, respectively. The user name and the password may be assigned to the user by the advisor owner or any other appropriate party. When the appropriate user name and password information are entered by the user, the advisor may provide the user access to some or all of the features found on the advisor system (e.g., modules, live experts, etc.). User log-on screen 800 may also include links to non-secure areas on the advisor system. Non-secure areas may be areas that do not require the user to enter login and password information in order for the user to obtain access. For example, user log-on screen 800 may include links 830, which may provide the user links to non-secure areas such as, for example, stock market information, product and service information, or any other suitable information.

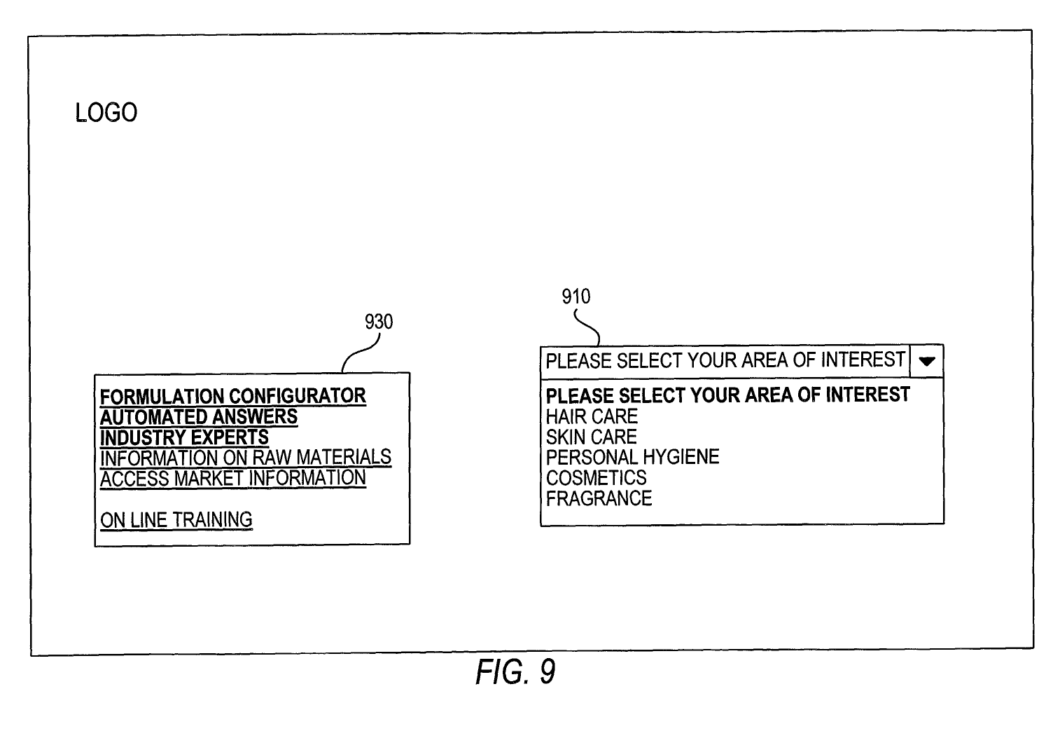

FIG. 9 shows an illustrative screen 900 for providing the user a list of user selectable areas of interest in order to assist the user in defining a query. This list of user selectable areas of interest may be provided to a user in, for example, drop-down box 910, or any in other suitable format for allowing a user to select from a list of options (e.g., check-boxes, text fields, etc.). Areas of interest that may be, for example, provided to the user in the personal care products industry may include areas such as, for example, hair care, skin care, personal hygiene, cosmetics, fragrances, etc. This list is only illustrative as any other suitable areas of interest for the personal care products industry may exist. Some embodiments of the present invention may include areas of interest for other industries such as, for example, automotive, aerospace, manufacturing, etc.).

Screen 900 may also include links 930, which may provide the user links to various secure and non-secure areas on the virtual advisor such as, for example, a formulation configurator link, an automated answers link, an industry experts link, a raw material information link, a market information link, an on-line training link, or a link to any other suitable screen, module, or information on the advisor system.

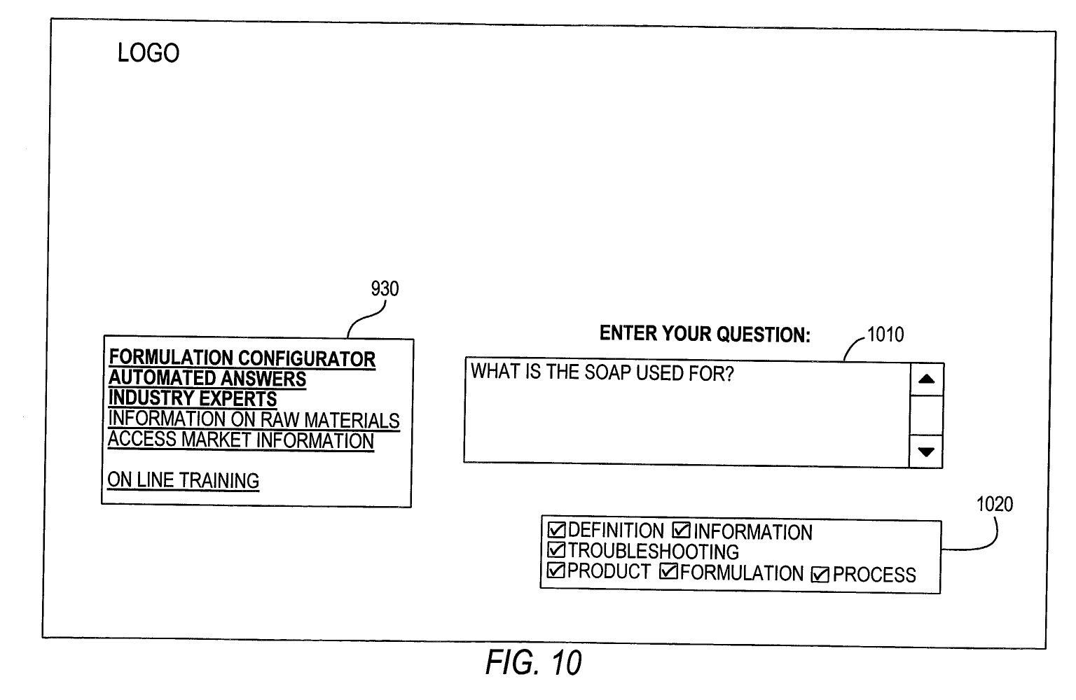

FIG. 10 shows an illustrative query entry screen 1000 that may be presented to a user in order to allow the user to enter a query. Query entry screen 1000 may, for example, include query entry region 1010, module selection region 1020, and links 930.

Query entry region 1010 may, for example, allow the user to enter a query. To enter a query, the user may utilize natural language semantics, markup language semantics, or any other suitable type of language semantics or method for entering a query, as discussed above.

Query entry screen 1000 may also include module selection region may 1020. Module selection region 1020 may, for example, allow the user to select one or more advisor modules to perform a search for the user's query. To allow users to select one or more modules, module selection region may include, for example, check-boxes, text fields, or any other suitable method for selecting one or more advisor modules. Query entry screen 1000 may also include links 930, as described above.

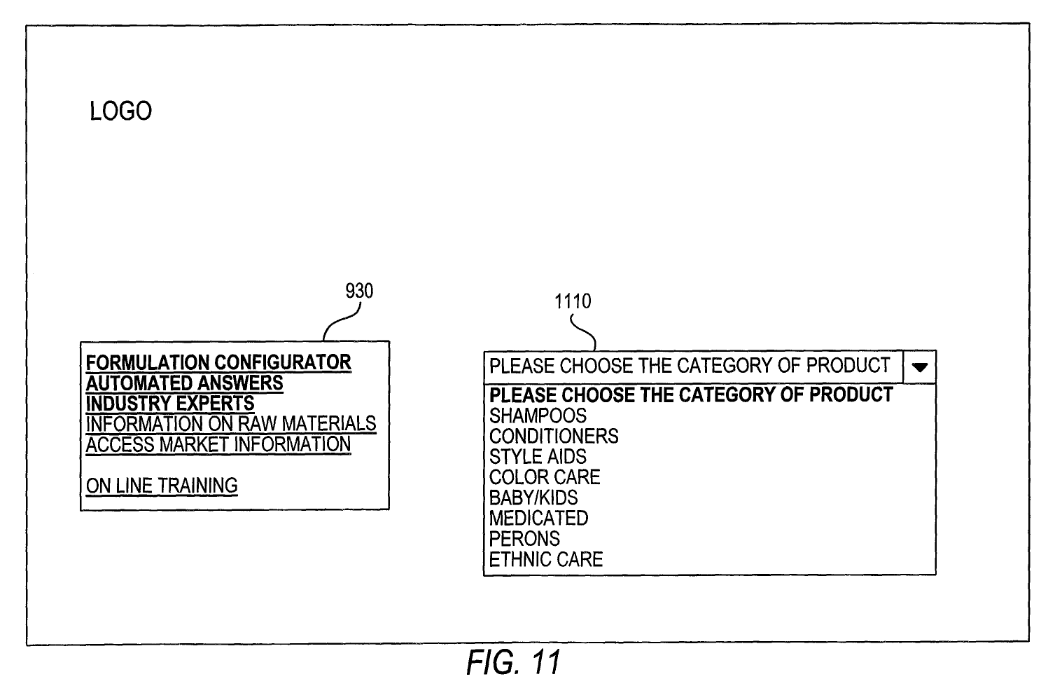

FIGS. 11-15 show illustrative additional screens that may be generated by the advisor and provided to the user in order to aid the user in defining a query. For example, in FIG. 11, when the user selects a particular product category in the personal care products industry (e.g., shampoos, conditioners, style aids, color care, baby/kids, medicated, ethic care, etc.) the user may be provided one or more lists of user selectable options in order to more particularly define the product category selected by the user.

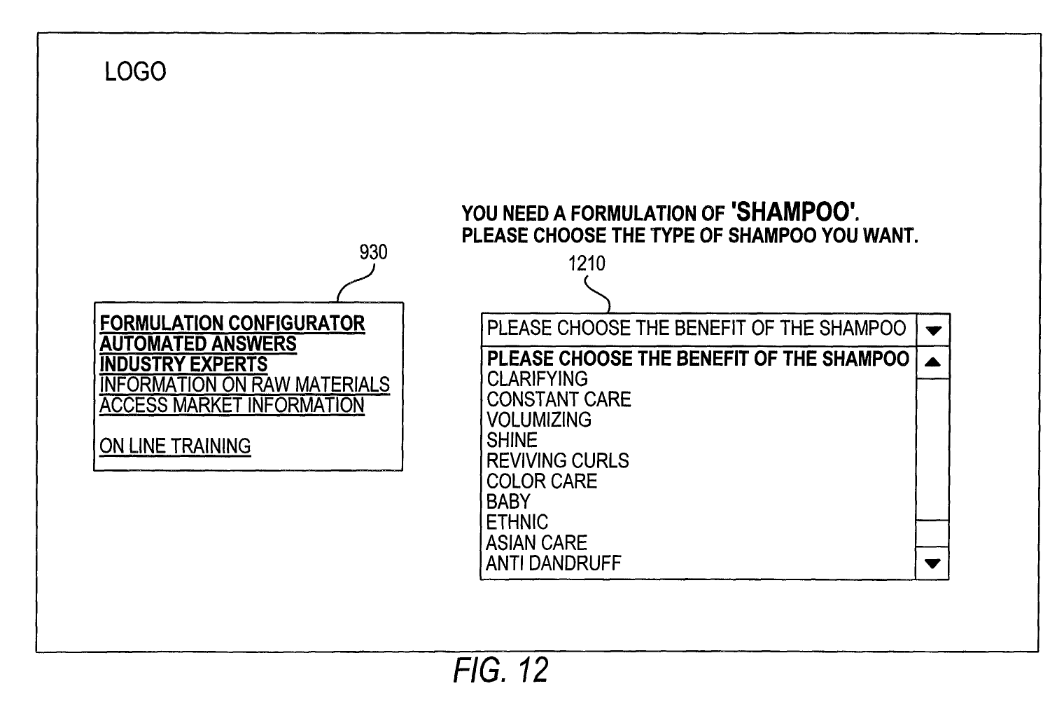

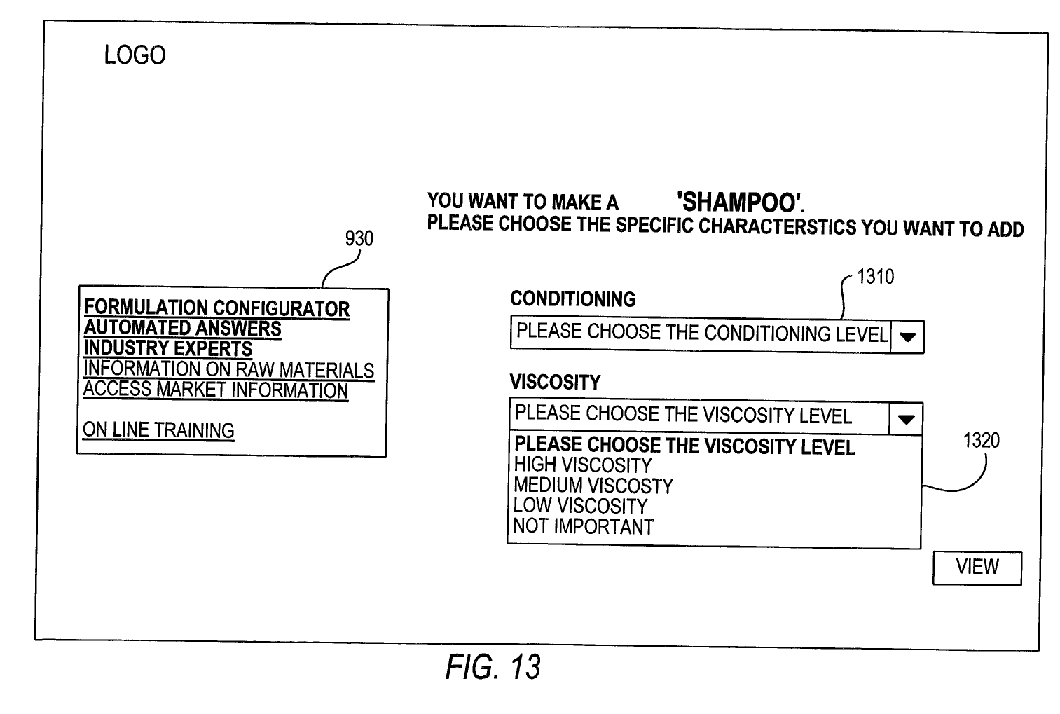

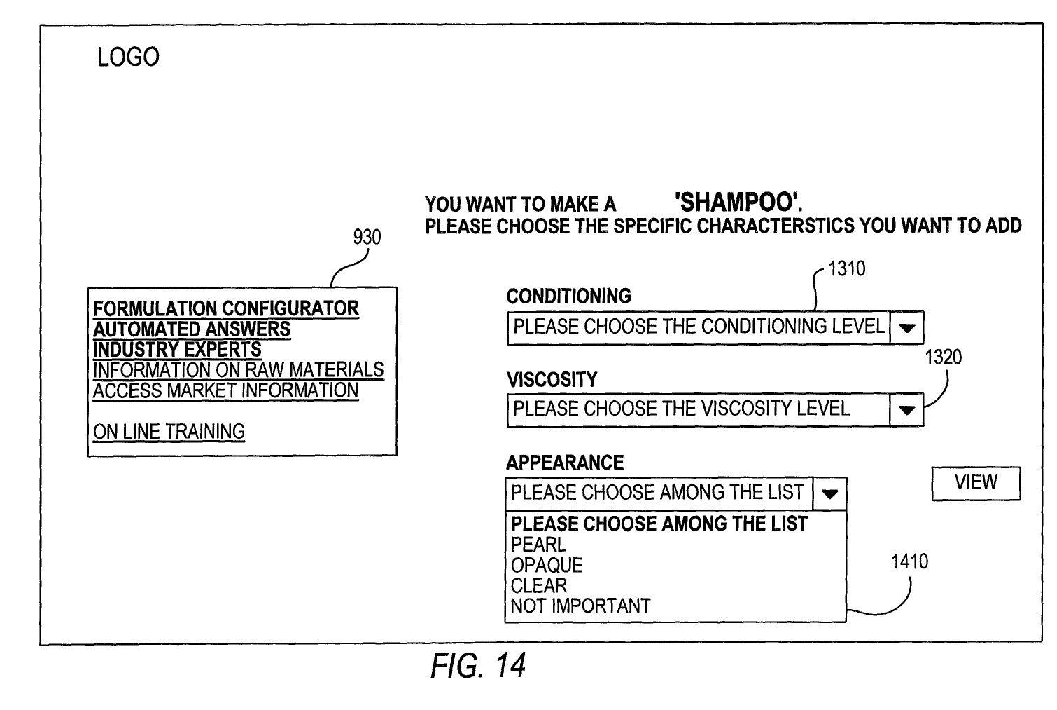

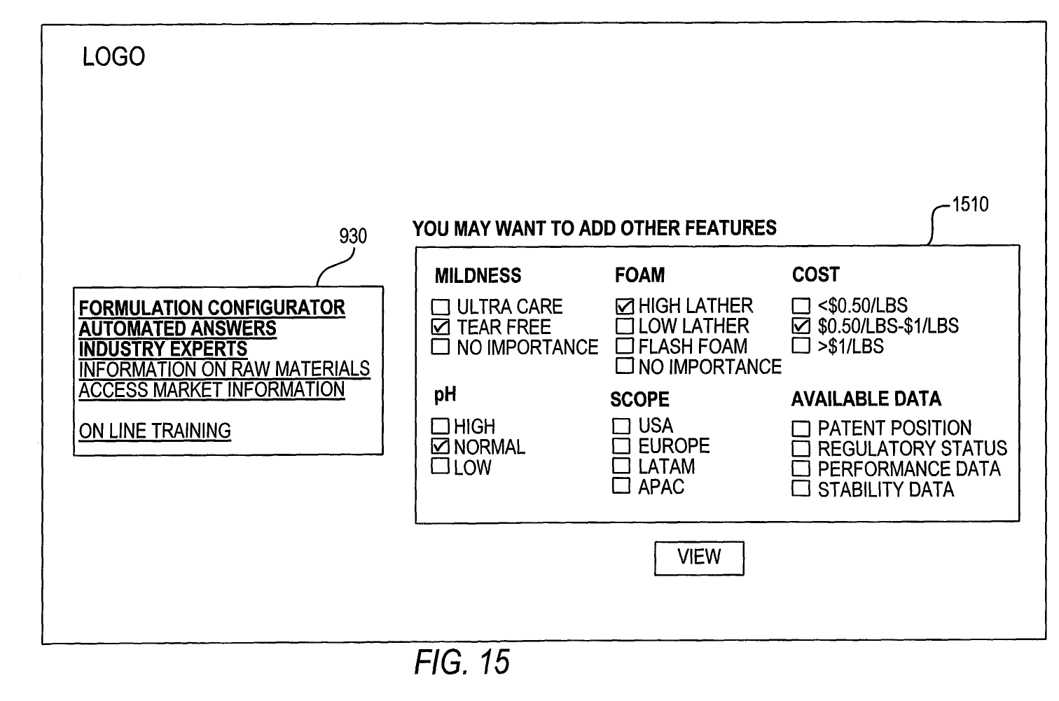

By way of illustration, when the user selects the product category “shampoo” provided in drop-down box 1110 (FIG. 11), the user may subsequently be provided drop-down box 1210 (FIG. 12), drop-down boxes 1310 and 1320 (FIGS. 13 and 14), drop-down box 1410 (FIG. 14), and check-boxes 1510 (FIG. 15) to more particularly define the product category “shampoo”. For example, to more particularly define the product category “shampoo” the user may be provided with selectable terms and characteristics in one or more successive screens, which may include, for example, clarifying, constant care, volumizing, shine, reviving curls, color care, baby, ethnic, Asian care, anti-dandruff, level of conditioning, viscosity, appearance (e.g., pearl, opaque, clear, etc.), mildness, PH, foam (e.g., high lather, low lather, flash foam, etc.), cost, available data, scope, etc. This list of terms and characteristics is only illustrative as any other suitable terms and characteristics may exist for more particularly defining the product category “shampoo” or any other personal care product category. Some embodiments of the present invention may include terms and characteristics that may define product categories for other industries such as, for example, automotive, aerospace, manufacturing, etc.).

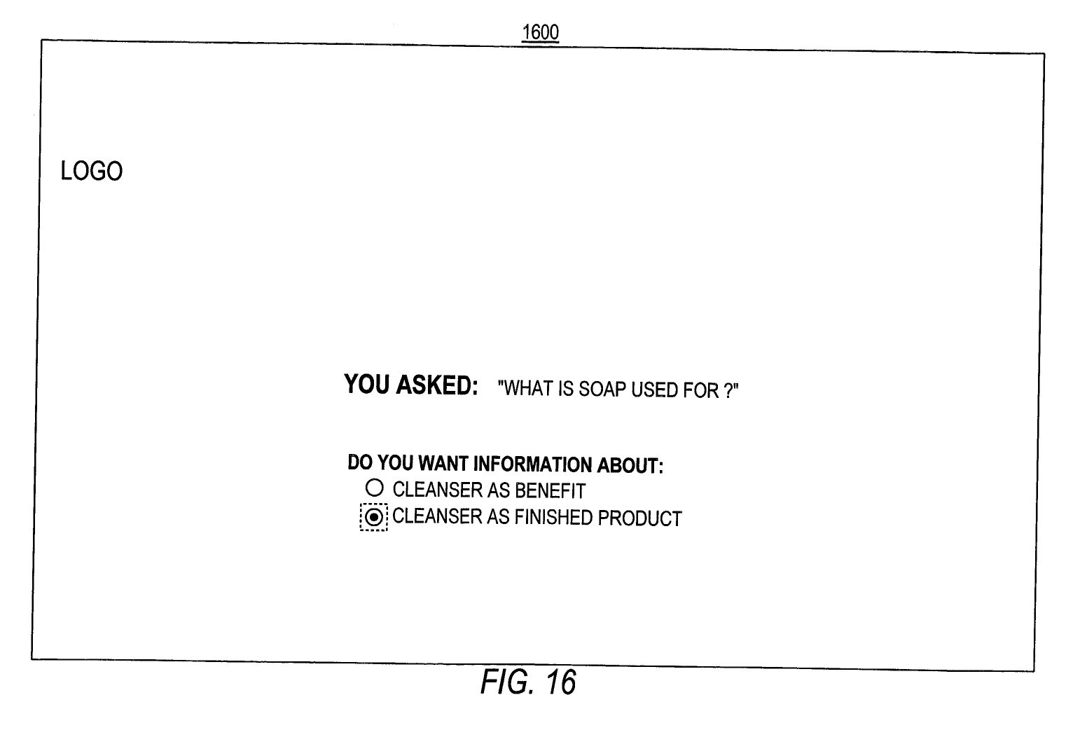

FIG. 16 shows illustrative advisor generated question screen 1600. Advisor generated question screen 1600 may be provided by the advisor to the user in order to more particularly define the user's query. For example, an advisor generated question, as described above, may be generated using case-based reasoning, a predefined rule, or both.

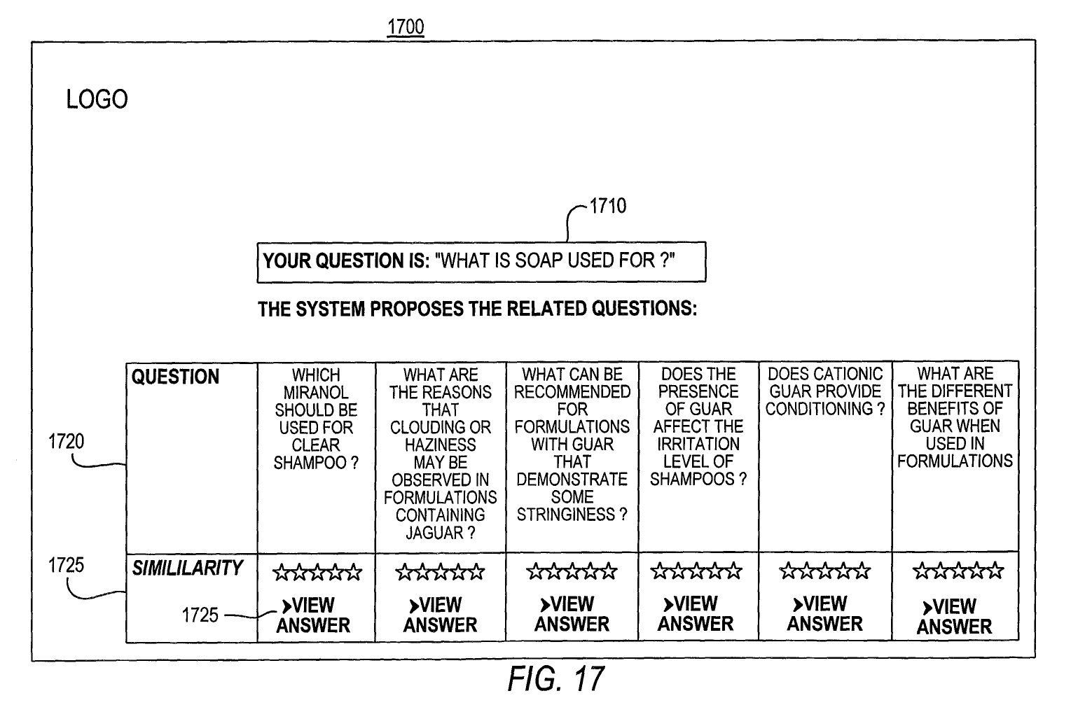

FIG. 17 shows illustrative solutions screen 1700. Solutions screen 1700 may be provided to the user based on the user's query and other information such as for example information generated by the advisor and provided to the user in order to more particularly define the user's query. Solutions screen 1700 may include question region 1710, which may be used to display the user's query. Solutions screen 1700 may also include related questions region 1720. Related questions region 1720 may include questions which were previously asked, answered, and stored on the advisor and that were selected by the advisor using case-based reasoning as questions that are sufficiently related to the user's query and that contain answers that may be a solution or part of a solution to the user's query. Related question region 1720 may also include similarity section 1725, which may, for example, use various techniques such as, for example, filled and unfilled stars to show the user how closely the previously asked, answered, and stored questions match the user's query. Similarity section 1725 may also include link 1727 or other suitable method to view an answer associated with a question found in region 1720.

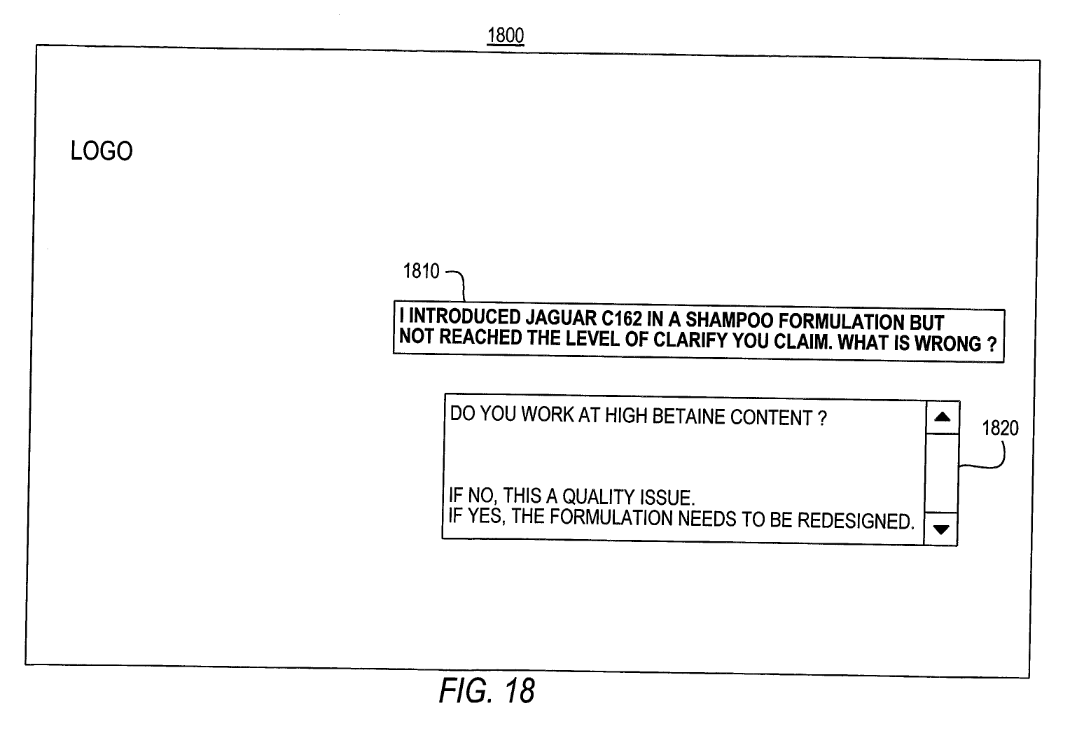

FIG. 18 shows an illustrative troubleshooting screen 1800. Troubleshooting screen 1800 may include user's query region 1810, which may display the user's troubleshooting query. Troubleshooting screen 1800 may also include troubleshooting technique region 1820. Troubleshooting technique region 1820 may, for example, provide the user information with respect to further clarifying the user's query and may also provide the user with specific troubleshooting information.

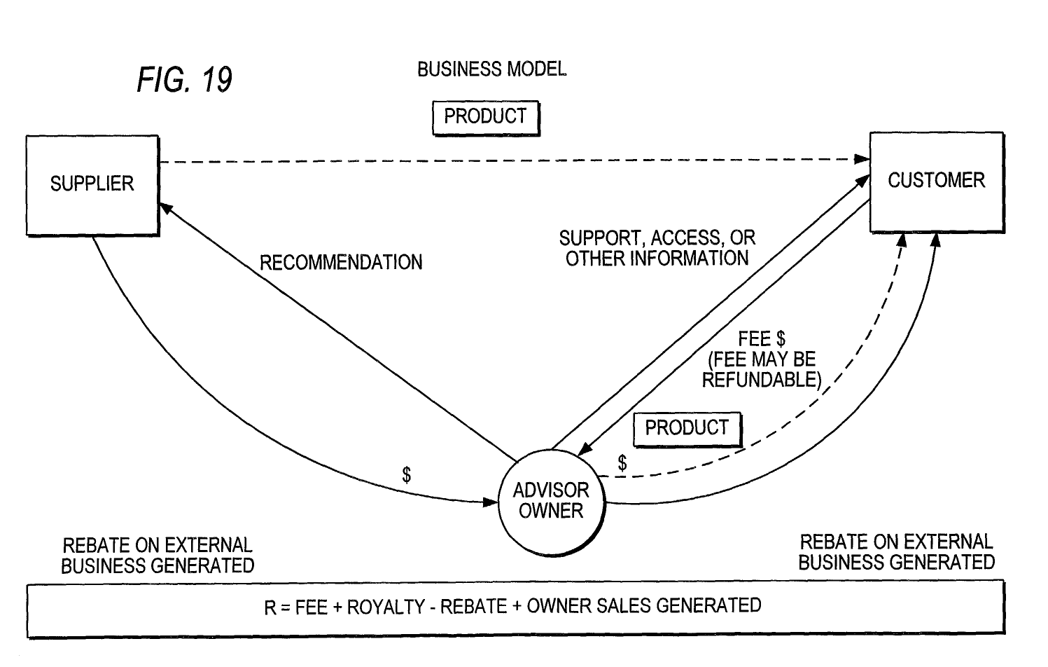

The virtual advisor may be used in connection with various business models. FIG. 19 is an illustrative example of a business model. For example, the owner of the virtual advisor system may provide system-related technical support, product-related support, or other types of support or information to a customer. A customer is any entity that utilizes the advisor system. In exchange for this access, support, or information, the customer may pay an access fee (e.g., flat fee, royalty, etc.) to access the advisor system, to receive support, or to receive information. Customers that utilize the advisor system with a predetermined frequency determined by the owner of the advisor system or the advisor system itself may be eligible receive a refund of either all or a fractional portion of their access fee.

In some embodiments, the chosen business model may include the owner of the advisor system, and/or the advisor system itself, giving customers a supplier recommendation. Suppliers are entities that may be under an outsourcing agreement or other suitable agreement with the owner of the advisor system to provide, for example, technologies, products, services, or capacity that the owner of the advisor system cannot provide. In exchange for these recommendations, the supplier may pay a recommendation fee (e.g., a flat fee, a royalty, or other suitable compensation) to the owner of the advisor system. In some embodiments the recommendation fee or a portion thereof paid by suppliers to the advisor's owner may be passed along to customers in the form of a rebate, additional access, etc.

In some embodiments, the chosen business model may include the owner of the advisor system providing customers rebates, discounts, or other forms of monetary or non-monetary benefits. These rebates, discounts, and benefits may be offered directly from the owner of the advisor system or from a third party provider. A third party provider may be an individual or entity that purchases access to the advisor system in large blocks or other suitable units. After purchasing such blocks or other suitable units, the third party provider may repackage the blocks or units into smaller sub-units. Repackaging the blocks or units into sub-units allows individuals and entities with relatively small financial resources to obtain access to the advisor system. These rebates, discounts or benefits may be generated by the advisor system. Any rebates, discounts, or benefits offered may be tracked or monitored through a proof of purchase system or any other suitable system.

The above business model examples may provide incentives to the owner of the advisor system, to suppliers, and to customers by providing increased and directed advertising, discounts, and other tangible and intangible benefits.

Thus, systems and methods for providing a virtual advisor are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for providing electronic advice to users of a virtual advisor comprising:
receiving an electronic query from a user, wherein the query identifies a problem for which the user desires a solution;
attempting to determine a solution for the user's query using case-based reasoning; and
providing the user with electronic access to a live expert to receive advice on the user's query when a solution to the user's query cannot be determined using case-based reasoning.

2. The method of claim 1 wherein the user's query includes an identification of a system module in which the virtual advisor process the query.

3. The method of claim 1 further comprising providing questions to the user from the virtual advisor to further define the user's query in response to the virtual advisor determining that additional information is needed to determine a solution for the user's query, wherein the questions include questions that are generated by the virtual advisor using case-based reasoning.

4. The method of claim 3 wherein the questions include questions generated based on at least in part information provided by the user in the user's query.

5. The method of claim 1 wherein the live expert is chosen by the virtual advisor using case-based reasoning.

6. The method of claim 5 wherein the live expert is chosen by the virtual advisor based upon at least in part the particular expertise of the live expert.

7. The method of claim 5 wherein the live expert is chosen by the virtual advisor based upon at least in part the financial amount charged by the live expert.

8. The method of claim 1 further comprising:
providing the query to the live expert; and
providing a notification to the user in response to the live expert's receipt of the user query.

9. A method for providing electronic advice to users of a virtual advisor comprising:
electronically providing the user the opportunity to enter a query and to select a system module, wherein the query identifies a problem for which the user desires a solution, and wherein the system module is a location on the virtual advisor where the user desires submit a query;
determining whether additional information is needed to perform a search with respect to the user's query using one of 1) a predefined rule, 2) cased-based reasoning, and 3) a predefined rule and case-based reasoning;
providing questions to the user from the virtual advisor to further define the user's query in response to the virtual advisor determining that additional information is needed to perform a search with respect to the user's query, wherein the questions provided include questions that are generated by the virtual advisor using case-based reasoning.
providing the user with one or more user selectable solutions to the user's query;
receiving a user selection of a provided solution;
providing information on or related to the selected solution.

10. The method of claim 9 further comprising:
providing the user with the opportunity to electronically submit a query to a live expert;
electronically submitting the query to a live expert; and
providing a notification to the user that the query was submitted successfully to the live expert.

11. A system for providing electronic advice to users of a virtual advisor comprising:
means for receiving an electronic query from a user, wherein the query identifies a problem for which the user desires a solution;
means for attempting to determine a solution for the user's query using case-based reasoning; and
means for providing the user with electronic access to a live expert to receive advice on the user's query when a solution to the user's query cannot be determined using case-based reasoning.

12. The system of claim 11 wherein the user's query includes an identification of a system module in which the virtual advisor process the query.

13. The system of claim 11 further comprising means for providing questions to the user from the virtual advisor to further define the user's query in response to the virtual advisor determining that additional information is needed to determine a solution for the user's query, wherein the questions include questions that are generated by the virtual advisor using case-based reasoning.

14. The system of claim 13 wherein the questions include questions generated based on at least in part information provided by the user in the user's query.

15. The system of claim 11 wherein the live expert is chosen by the virtual advisor using case-based reasoning.

16. The system of claim 15 wherein the live expert is chosen by the virtual advisor based upon at least in part the particular expertise of the live expert.

17. The system of claim 15 wherein the live expert is chosen by the virtual advisor based upon at least in part the financial amount charged by the live expert.

18. The system of claim 11 further comprising:
means for providing the query to the live expert; and
means for providing a notification to the user in response to the live expert's receipt of the user query.

19. A system for providing electronic advice to users of a virtual advisor comprising:
means for providing the user the opportunity to enter a query and to select a system module, wherein the query identifies a problem for which the user desires a solution, and wherein the system module is a location on the virtual advisor where the user desires submit a query;
means for determining whether additional information is needed to perform a search with respect to the user's query using one of 1) a predefined rule, 2) cased-based reasoning, and 3) a predefined rule and case-based reasoning;
means for providing questions to the user from the virtual advisor to further define the user's query in response to the virtual advisor determining that additional information is needed to perform a search with respect to the user's query, wherein the questions provided include questions that are generated by the virtual advisor using case-based reasoning;
means for providing the user with one or more user selectable solutions to the user's query;
means for receiving a user selection of a provided solution; and
means for providing information on or related to the selected solution.

20. The system of claim 19 further comprising:
means for providing the user with the opportunity to submit a query to a live expert;
means submitting the query to a live expert; and
means for providing a notification to the user that the query was submitted successfully to the live expert.
